(19) United States
(12) Patent Application Publication
(10) Pub. No.: US 2008/0240894 A1
(43) Pub. Date: Oct. 2, 2008

(54) Storage and retrieval system

(76) Inventor: Eric Reisenauer, Owego, NY (US)

Correspondence Address: MICHAEL BEST & FRIEDRICH LLP, 100 E WISCONSIN AVENUE, Suite 3300, MILWAUKEE, WI, 53202, US

(21) Appl. No.: 11/729,612

(22) Filed: Mar. 29, 2007

(51) Int. Cl. B65G 1/00

(52) U.S. Cl. 414/273; 414/801

(57) ABSTRACT

A storage and retrieval system that includes a track assembly and a carrier defining a support surface configured to support a product stored by the storage and retrieval system. The carrier includes a guide member rotatable with respect to the support surface from a first position to a second position such that the carrier is movable in a first direction when the guide member is in the first position and the carrier is movable in a second direction when the guide member is in the second position. The track assembly includes a track member coupled to the guide member. The track member is selectively rotatable from a first orientation to a second orientation such that the carrier is movable in the first direction when the track member is in the first orientation and the carrier is movable in the second direction when the track member is in the second orientation.

### BACKGROUND

The present invention relates to storage and retrieval systems.

Storage and retrieval systems can be used in warehouses, factories, and ships to store a product and then, at a later time, retrieve the product. Such systems typically include a carrier that supports the product, and the carrier often includes an on-board drive member to transport the carrier and the product. The carrier is often utilized to move the product between a loading location, a storage location, and a retrieval location. For example, the product can be loaded onto the carrier at the loading location. Then, the carrier can transport the product to a storage location where the product is stored until a user desires to use the product. The carrier can then transport the product to an unloading location where the user retrieves the product. Often, the storage and retrieval system in arranged in a matrix configuration to facilitate tracking the location of the products.

### SUMMARY

In one embodiment, the invention provides a storage and retrieval system that includes a carrier defining a support surface configured to support a product stored by the storage and retrieval system. The carrier includes a guide member rotatable with respect to the support surface from a first position to a second position such that the carrier is movable in a first direction when the guide member is in the first position and the carrier is movable in a second direction when the guide member is in the second position. The storage and retrieval system further includes a track assembly having a track member coupled to the guide member. The track member is selectively rotatable from a first orientation to a second orientation such that the carrier is movable in the first direction when the track member is in the first orientation and the carrier is movable in the second direction when the track member is in the second orientation.

In another embodiment, the invention provides a storage and retrieval system that includes a plurality of carriers arranged to define a matrix. The plurality of carriers are configured to support a product stored by the storage and retrieval system. At least one of the plurality of carriers is selectively movable in a first direction and a second direction. The storage and retrieval system further includes a drive member operable to move the at least one of the plurality carriers in the first direction and the second direction. The at least one of the plurality of carriers is movable with respect to the drive member.

In another embodiment, the invention provides a method of operating a storage and retrieval system. The method includes moving a carrier configured to support a product stored by the storage and retrieval system in a first direction, and guiding movement of the carrier in the first direction using a track member in a first orientation. The method further includes rotating the track member from the first orientation to a second orientation, and after rotating the track member, moving the carrier in a second direction.

Other aspects of the invention will become apparent by consideration of the detailed description and accompanying drawings.

### BRIEF DESCRIPTION OF THE DRAWINGS

FIG. 1 is a perspective view illustrating a storage and retrieval system embodying the present invention.

FIG. 2 is a perspective view illustrating the storage and retrieval system of FIG. 1 with a carrier moved from the position illustrated in FIG. 1.

FIG. 3 is a side view of a portion of the storage and retrieval system of FIG. 1 with guide members of the carrier in a first position.

FIG. 4 is a side view of a portion of the storage and retrieval system of FIG. 1 with the guide members of the carrier in a second position.

FIG. 5 is a side view of a portion of the storage and retrieval system of FIG. 1 illustrating the guide member in the first position.

FIG. 6 is a side view of a portion of the storage and retrieval system of FIG. 1 illustrating the guide member in the second position.

FIG. 7 is a perspective view of a portion of the storage and retrieval system of FIG. 1 illustrating track members in a first orientation.

FIG. 8 is a perspective view of the storage and retrieval system of FIG. 1 illustrating track members in a second orientation.

FIG. 9 is a side view of an alternative construction of the track and guide members of the storage and retrieval system of FIG. 1.

FIG. 10 is a schematic illustration of an alternative arrangement of the storage and retrieval system of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

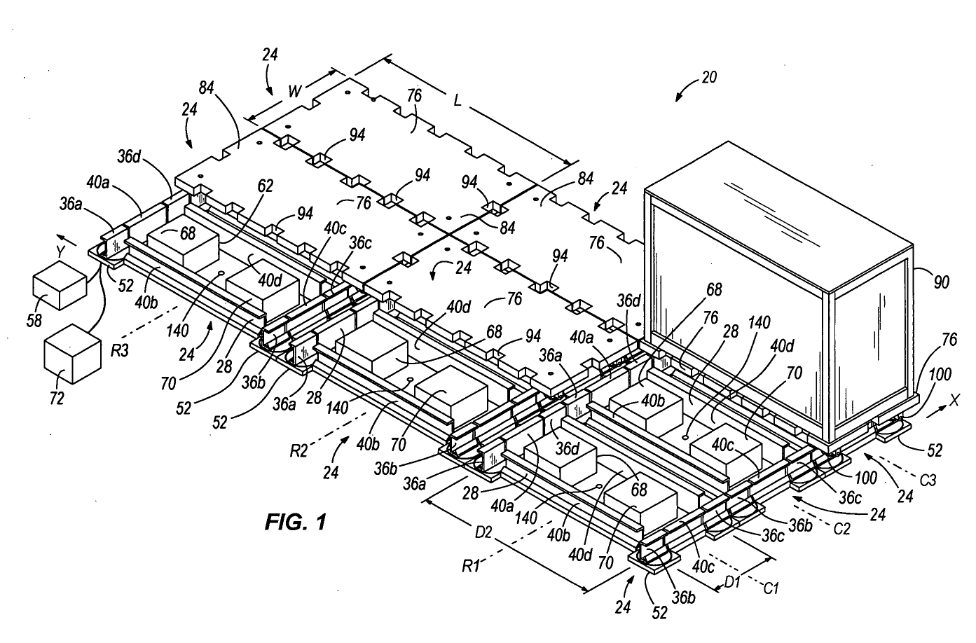

FIG. 1 illustrates a storage and retrieval system 20. The storage and retrieval system 20 is operable to store and transport products. In one application, the storage and retrieval system 20 can be used to store and transport products on a ship. In other applications, the storage and retrieval system 20 can be utilized in warehouses, factories, etc.

With continued reference to FIG. 1, the storage and retrieval system 20 includes cells or units 24 that are arranged along an x-axis and a y-axis to define a matrix having rows R1, R2, R3 and columns C1, C2, C3. While FIG. 1 illustrates nine units 24 arranged in a three-by-three matrix, it should be understood that the storage and retrieval system 20 can include any suitable number of units 24 arranged to define any suitably sized or configured matrix.

Each of the units 24 is substantially the same and therefore only one of the units 24 will be described in detail below and like components have been given like references numbers.

The illustrated unit 24 of the storage and retrieval system 20 includes a track assembly 28. The illustrated track assembly 28 includes rotatable track members 36a, 36b, 36c, 36d and generally fixed track members 40a, 40b, 40c, 40d. In one construction, the track members 36a-36d and 40a-40d are formed from hardened steel and in other constructions, the track members can be formed from other suitable materials.

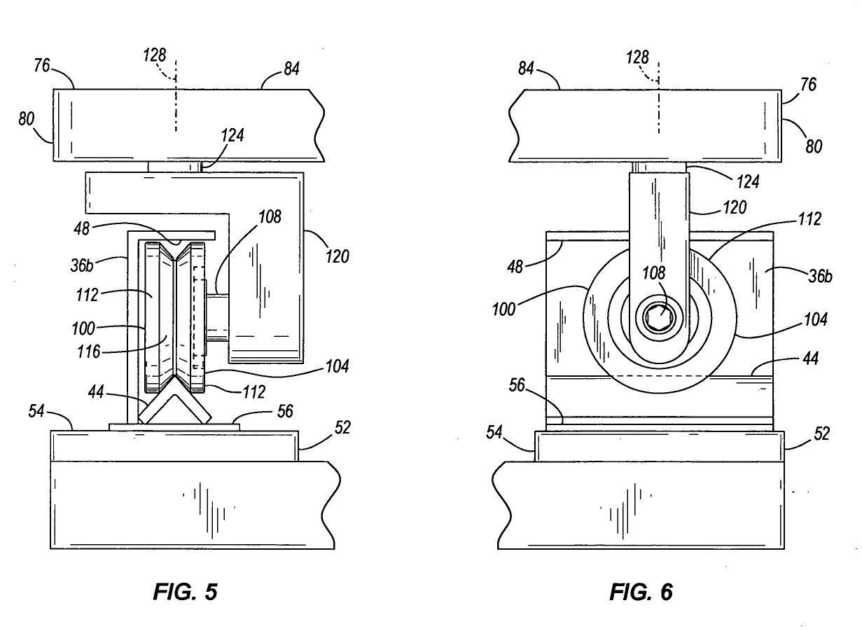

Referring to FIGS. 5-8 the track members 36a-36d and 40a-40d include a rail portion 44 and a flange portion 48. As best seen in FIG. 5, the illustrated rail portion 44 defines a cross section that is generally V-shaped and the illustrated flange portion 48 is located above the rail portion 44.

Referring to FIG. 1, the fixed track members 40b and 40d are spaced a distance D1 and are oriented substantially parallel to the y-axis, and the fixed track members 40a and 40c are spaced a distance D2 and are oriented substantially parallel to the x-axis. Accordingly, the illustrated track members 40b and 40d are oriented generally normal to the track members 40a and 40c and the track members 40a-40d define corner regions at which one of the rotatable track members 36a-36d are located.

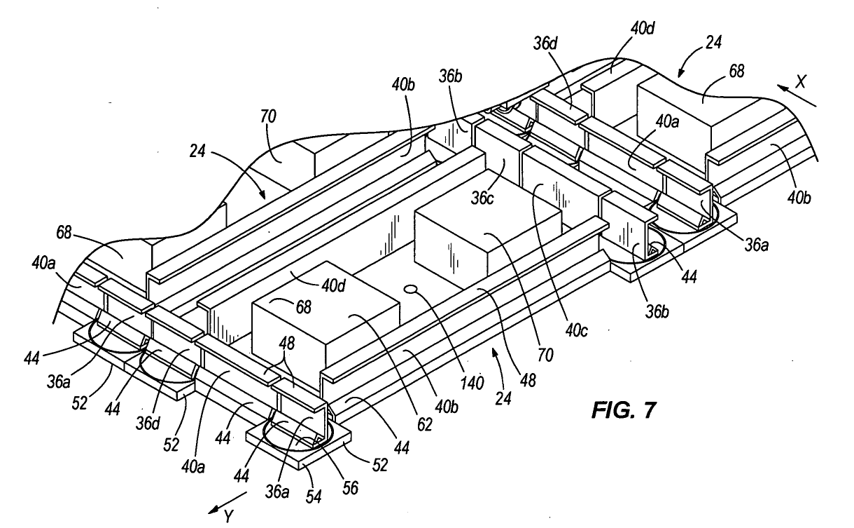

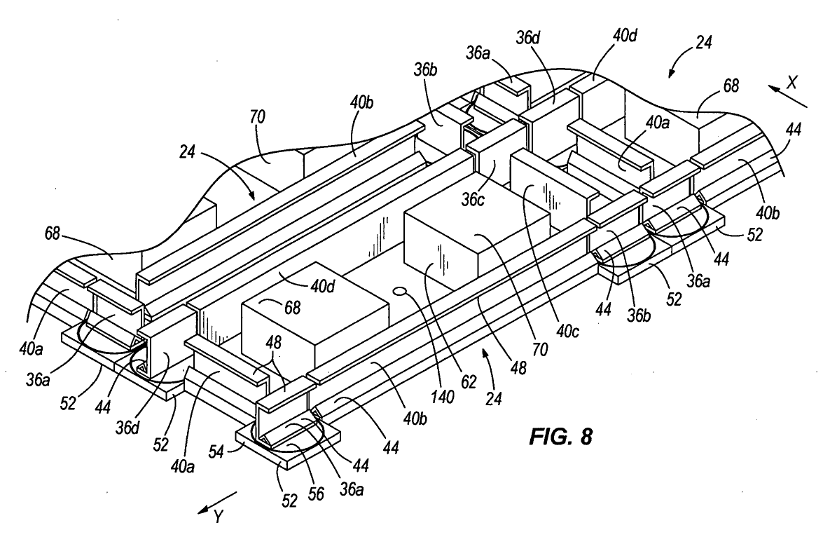

Referring to FIGS. 7 and 8, the rotatable track members 36a-36d are each coupled to a base 52. The bases 52 include a generally fixed portion 54 and a rotatable portion 56 that rotates with respect to the fixed portion 54. Each of the track members 36a-36d is coupled to a rotatable portion 56 of a base 52 such that the track members 36a-36d are rotatable with respect to the fixed portion 54 of each base 52.

A drive member, such as a motor or other similar device, can be housed within each of the bases 52 and utilized to rotate respective track members 36a-36d. In other constructions, any suitable drive member can be utilized to rotate the track members 36a-36d. As illustrated in FIG. 1, a controller 58 is utilized to control the drive members that rotate the track members 36a-36d. The controller 58 can be any suitable controller, such as a computer, a programmable logic controller (PLC), and the like.

With continued reference to FIGS. 7 and 8, the track members 36a-36d are rotatable from a first orientation (FIG. 7) to a second orientation (FIG. 8). In the first orientation, the rails 44 of the track member 36a and 36d are aligned with the rail 44 of the track member 40a, and the rails 44 of the track members 36b and 36c are aligned with the rail 44 of the track member 40c (see FIG. 1). Therefore, in the first orientation the track members 36a-36d are substantially parallel to the x-axis. In the second orientation, the track members 36a-36d are rotated approximately 90 degrees from the first orientation such that the rails 44 of the track members 36a and 36b are aligned with the rail 44 of the track member 40b, and the rails 44 of the track members 36d and 36c are aligned with the rail 44 of the track member 40d. Therefore, in the second orientation the track members 36a-36d are substantially parallel to the y-axis.

The bases 52 can include mechanical, electrical, or electromechanical stops or positioning devices to locate the respective track members 36a-36d in the first and second positions such that the rails 44 of the respective rotatable track members 36a-36d align with the rails 44 of the respective fixed track members 40a-40d. Such positioning devices can be controlled using the controller 58.

The unit 24 further includes a drive assembly 62. The drive assembly 62 includes drive members that are induction motors in the illustrated construction having stators 68 and 70. Of course, in other constructions, the unit 24 may include more or less than two stators. The stators 68 and 70 are substantially fixed to a floor that supports the storage and retrieval system 20. In other constructions, the drive members can include other suitable drive members such as linear synchronous motors. In yet other constructions, other suitable drive members, including other types of electric motors, such as stepper motors, can be utilized. Such constructions may also utilize mechanical drive members, including, belts, gear, etc.

Referring to FIG. 1, the illustrated storage and retrieval system 20 further includes a controller 72. The controller 72 can be any suitable controller such as a computer, programmable logic controller (PLC), and the like. The controller 72 is in electronic communication with the units 24 and the controller 72 controls the drive assemblies 62. While the controller 72 that controls the drive assemblies 62 is illustrated as a separate controller from the controller 58 that controls the track members 36a-36d, in other constructions, a single controller can be utilized to control both the drive assemblies 62 and the rotatable track members 36a-36d.

Referring to FIG. 1, the storage and retrieval system 20 further includes carriers 76. Each of the carriers 76 are substantially the same, and therefore only one carrier 76 will be described in detail and like components have been given like reference numbers.

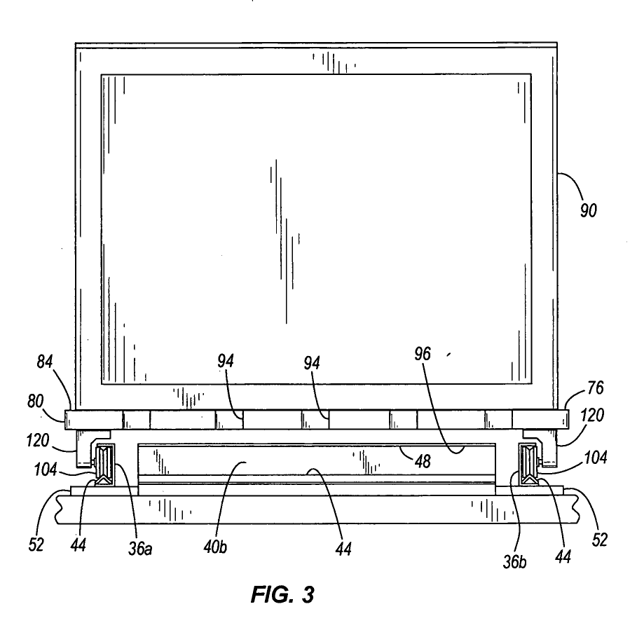

Referring to FIGS. 1 and 3, the carrier 76 includes a base or platform 80 that defines a support surface 84. The support surface 84 supports products stored by the storage and retrieval system 20. In the illustrated construction, the products are stored in a crate 90. In other constructions, the support surface 84 can support standard pallets, skids, boxes, other forms of crates, and the like that are utilized to store the products.

As best seen in FIG. 1, the base 80 defines a length L and a width W. In one construction, the length L is approximately 40 inches and the width W is approximately 48 inches, which, as would be understood by one of skill in the art, corresponds to the dimensions of a standard pallet or skid. In other constructions, the length L and the width W can be multiples of the standard pallet (i.e., a length L of approximately 80 inches, 120 inches, etc., and/or a width W of approximately 96 inches, 144 inches, etc.) In yet other constructions, the base can have any suitable length L and width W and can be scaled to any suitable dimension for the particular application of the storage and retrieval system.

The base 80 defines pockets 94. The pockets 94 can receive fasteners, such as clamps, hooks, blocks, etc. to couple adjacent carriers 76 such that the carriers 76 move together. In one application, it may be desirable to couple carriers if products stored by the storage and retrieval system 20 have dimensions larger than the width W and the length L of one of the bases 80.

Referring to FIG. 3, a reaction plate 96, which forms a portion of the induction motors, is coupled to an underside of the base 80 of the carrier 76, opposite the support surface 84. The reaction plate 96 is utilized with the stators 68 and 70 of the induction motors to drive the carrier 76. The reaction plate 96 is formed from an electrically conductive material, such as aluminum, copper, etc. In other embodiments, such as embodiments that utilize linear synchronous motors, as would be understood by one of skill in the art, the reaction plate 96 is typically replaced with either magnets or windings.

Referring to FIGS. 1 and 4-6, the carrier 76 further includes a guide member 100. The illustrated guide member 100 includes wheels 104 that are rotatably supported on a respective support shaft 108. As best seen in FIG. 5, the wheels 104 include a circumferential surface 112 and a V-shaped recess 116 that extends radially inwardly from the circumferential surface 112. The V-shaped recess 116 of the wheel 104 receives the rail 44 such that the wheel 104 is guided as the wheel rolls along the rail 44. In the illustrated construction, the track members 36a-d and 40a-d include the flange portion 48 that is located above the wheel 104 when the wheel 104 is located on the rail 44. Therefore, the wheels 104 are captured between the rail 44 and the flange 48 and the flange 48 substantially prevents movement of the wheel 104 in an upward directly that may cause the wheels 104 to uncouple from the rail 44.

In one construction, the circumferential surface 112 and a portion of the V-shaped recess 116 are formed with a wear surface, such as a polymer or rubber wear surface to inhibit slipping of the wheel 104 as it rolls along the rail 44 or as the wheel 104 rolls along a flat surface, such as a floor. In one construction, the wear surface has a coefficient of friction between about 1.0 to about 4.0.

Referring to FIGS. 5 and 6, the support shaft 108 is coupled to a support arm 120. The support arm 120 is coupled to the base 80 of the carrier 76 by a support arm shaft 124. The support arm shaft 124 is received by the base 80 such that the support arm shaft 124 is rotatable about an axis 128 that is substantially normal to the support surface 84 of the base 80. Therefore, rotation of the rotatable track members 36a-36d from the first orientation (FIG. 5) to the second orientation (FIG. 6) causes a corresponding rotation of the respective wheel 104 from a first position (FIG. 5) to a second position (FIG. 6) while the base 80 remains in the same position.

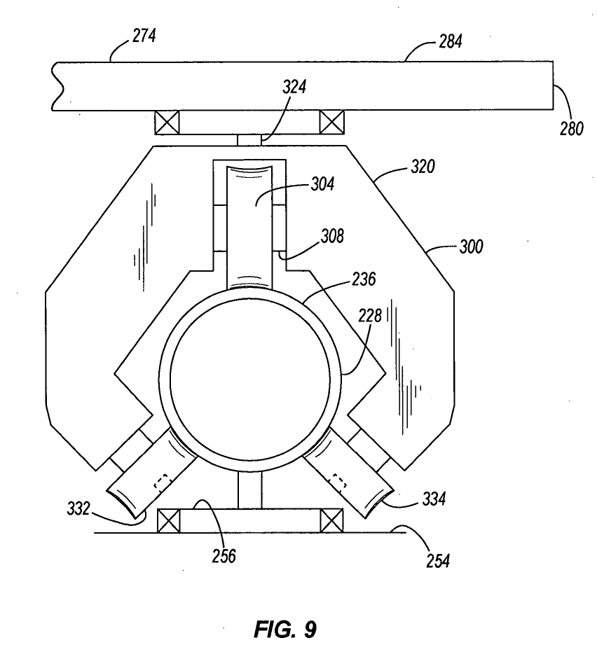

FIG. 9 illustrates an alternative construction of the guide member 100 and track assembly 28 of FIGS. 1-8. The guide member 300 and the track assembly 228 of FIG. 9 are substantially the same and therefore similar components have been given similar reference numbers plus 200.

In the construction illustrated in FIG. 9, the track members 236a-236d and 240a-240d of the track assembly 228 are formed from pipes rather than the rails 44 and the flanges 48 of FIGS. 1-8. In the illustrated construction, the pipes are standard 4 inch diameter steel pipes. Of course, in other constructions, outer sizes of pipes formed from other suitable materials can be utilized.

The guide member 300 of the embodiment illustrated in FIG. 9, includes the wheel 304 that rolls along the track members 236a-236d and 240a-240d. Retaining wheels 332 and 334 are rotatably coupled to the support are 320 such that the retaining wheels 332 and 334 roll along the track members 236a-236d and 240a-240d. The retaining wheels 332 and 334 facilitate maintaining contact between the wheel 304 and the track members 236a-236d and 240a-240d.

Operation of the embodiment illustrated in FIG. 9 is substantially the same as the operation of the embodiment illustrated in FIGS. 1-8 and operation of the storage and retrieval system 20 will be described in reference to the embodiment illustrated in FIGS. 1-8.

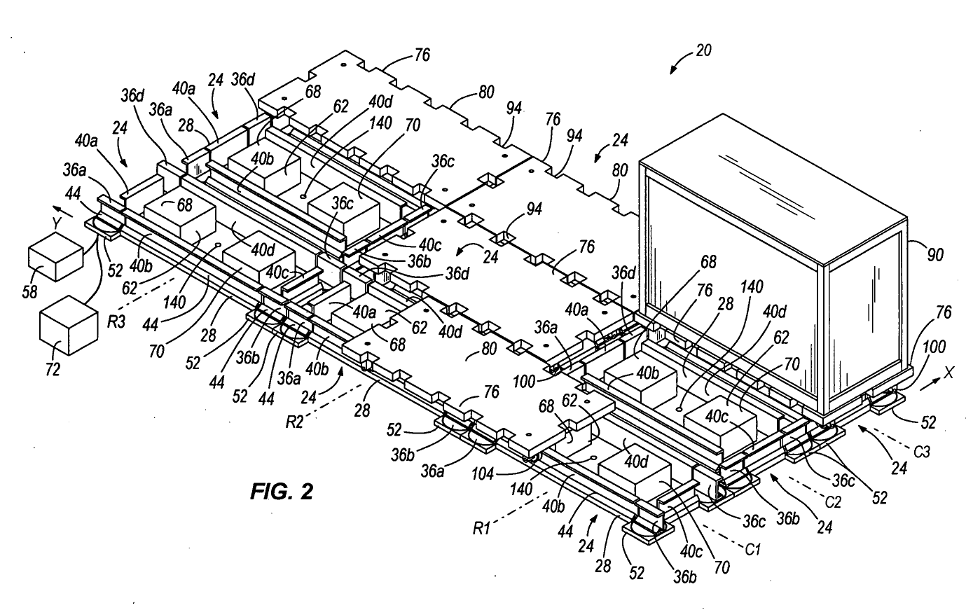

Referring to FIGS. 1 and 2, the storage and retrieval system 20 is operable to move the carriers 76 between the cells or units 24. For example, referring to FIG. 1, the carrier 76 located at the unit 24 at column C2, row R3 can be moved to any open unit 24 (i.e., a unit that does not have a carrier 76 located at the respective track assembly 28), such as the unit 24 located at column C1, row R1 in the illustrated construction.

Referring to FIGS. 1 and 7, to move the carrier 76 located at column C2, row R3 in FIG. 1 in the x-direction to column C1, row R3, the rotatable track members 36a-36d remain in the first orientation as illustrated in FIGS. 1 and 7 such that the track members 36a-36d are generally parallel to the x-axis. Therefore, the rails 44 of the rotatable track members 36a and 36d are aligned with the rail 44 of the fixed track member 40a and the rails 44 of the rotatable track members 36c and 36b are aligned with the rail 44 of the fixed track member 40c. Then, the stators 68 and 70 of the induction motors are located within the unit 24 at column C1, row R3 are activated to induce a current in the reaction plate 96 (FIG. 3) that is coupled to the bottom of the carrier 76 at column C2, row R3. By activating the stators 68 and 70 at column C1, row R3, the adjacent carrier 76, having the reaction plate 96, at column C2, row R3 is magnetically attracted or pulled toward the stators 68 and 70 at column C1, row R3 to move the carrier 76 in the x-direction toward column C1, row R3. As the carrier 76 moves in the x-direction, the track members 36a-36d and 40a and 40c guide the movement of the carrier 76 because the wheels 104 of the carrier 76 receive the rails 44 (see FIG. 5).

The carrier 76 moves in the x-direction until the carrier 76 is properly positioned with respect to the unit 24 at column C1, row R3. When the carrier 76 is properly positioned at column C1, row R3, the stators 68 and 70 of the induction motors at column C1, row R3 can be deactivated, and therefore the stators 68 and 70 at column C1, row R3 no longer move the carrier 76. The carrier 76 is properly positioned with respect the unit 24 when the wheels 104 of the carrier 76 are each supported on respective rotatable track members 36a-36d. Position sensors 140 and the like can be utilized to determine when the carrier 76 is properly positioned with respect to the unit 24. For example, the base 80 of the carrier 76 and the unit 24 may include the position sensors 140 that substantially align to determine when the carrier 76 is properly positioned with respect to the unit 24.

After the carrier 76 is properly positioned with respect to the unit 24 at column C1, row R3, the rotatable track members 36a-36d are rotated to the second orientation (FIG. 8). Comparing FIGS. 7 and 8, in the illustrated construction, the first orientation is approximately 90 degrees from the second orientation. In other constructions, the track assembly 28 can be arranged such that the first orientation is more or less than 90 degrees from the second orientation.

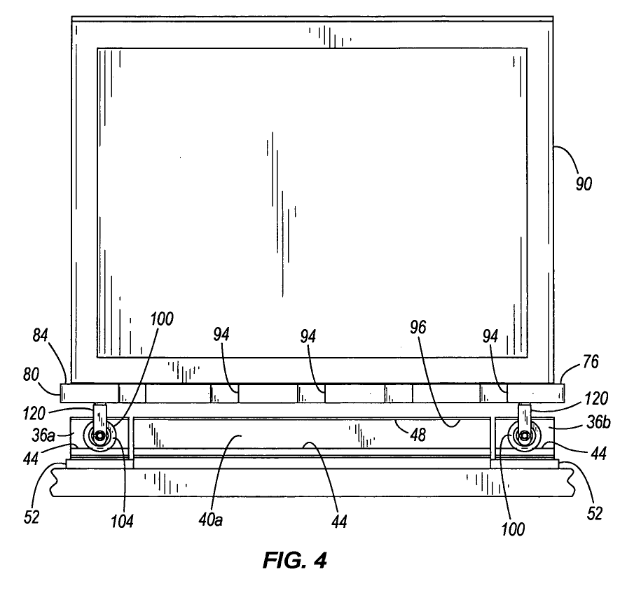

Referring to FIGS. 3 and 4, when the rotatable track members 36a-36d (only track members 36a and 36b visible in FIGS. 3 and 4) rotate from the first orientation (FIG. 3) to the second orientation (FIG. 4), the guide members 100, which include the wheels 104 in the illustrated construction, also rotate from the first position (FIG. 3) to the second position (FIG. 4). Furthermore, as illustrated in FIGS. 2 and 8, the rotatable track members 36a-36d of the adjacent unit 24, located at column C1, row R2, are also placed in the second orientation such that the track members 36a and 36d of the unit 24 at column C1, row R2 align with respective track members 36b and 36c of the unit at column C1, row R1. In the second orientation, the rails 44 of the rotatable track members 36a-36d are aligned with respect rails 44 of the fixed track members 40b and 40d that are generally parallel to the y-axis. Accordingly, the track assemblies 28 of the units 24 at column C1, rows R1 and R2 are orientated to facilitate guiding the carrier 76 for movement in the y-direction.

With the track assembly 28 in the second orientation, the stators 68 and 70 of the induction motors of unit 24 at column C1, row R2 are activated to attract or pull the reaction plate 96 (see FIG. 4), as discussed above, to move the carrier 76 in the y-direction. When the carrier 76 is received at column C1, row R2, the stators 68 and 70 of the induction motors at column C1, row R2 are deactivated and the stators 68 and 70 of the induction motors at column C1, row R1 are activated to continue moving the carrier 76 in the y-direction. The rotatable track members 36a-36d of the unit 24 at column C1, row R1 are also placed in the second orientation to receive the carrier 76.

The activation and deactivation of the stators 68 and 70 are controlled by the controller 72 to move the carriers 76 to any of the units 24. The controller 72 can also be used to control the magnitude and the direction of the magnetic field created by the stators 68 and 70. The magnetic field can be controlled to increase or decrease the speed at which the carriers 76 travel. The direction of the magnetic field is controlled to change the direction the carriers 76 travel.

While the foregoing description describes movement of just one carrier 76 of the storage and retrieval system 20, a substantially similar method as the method described above can be utilized to move any of the carriers 76 of the storage and retrieval system 20 of FIG. 1 in the x-direction or y-direction to any of the units 24.

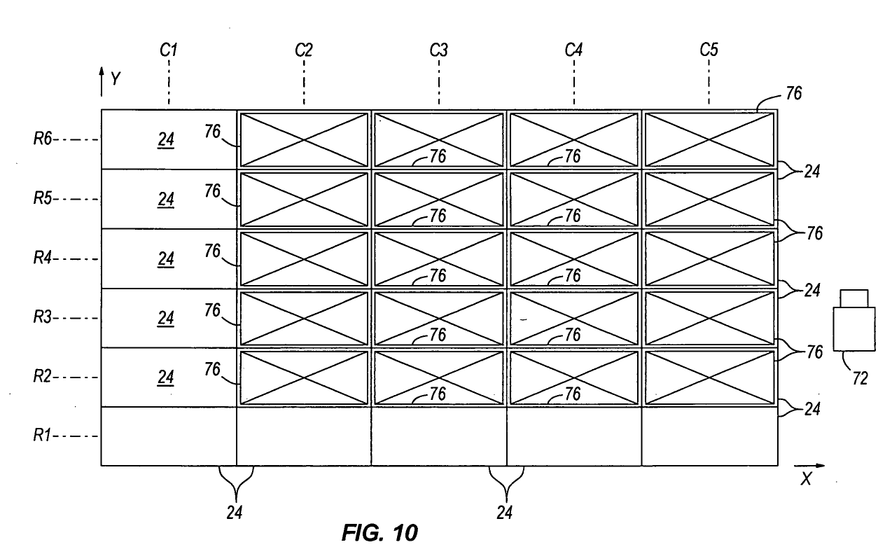

For example, FIG. 10 schematically illustrates an alternative arrangement of the storage and retrieval system 20 of FIGS. 1 and 2. Representative components illustrated in FIG. 10 have been given the same reference number as the component they represent in FIGS. 1-8.

In the arrangement illustrated in FIG. 10, the storage and retrieval system 20 includes five columns (C1-C5) and six rows (R1-R6) such that the units 24 define a five-by-six matrix with a total of thirty units 24. Of course, other suitable arrangements of the units 24 can be utilized. The illustrated arrangement of the storage and retrieval system 20 also includes twenty carriers 76. The carriers 76 are arranged such that the units 24 that define column C1 and the units 24 that define row R1 do not include a respective carrier 76. Row R1 and column C1 are known as a pick lane or transfer lane.

The carrier 76 located at column C2, row R6 can be moved in the x-direction, as discussed above, into column C1 and then moved in the y-direction to row R1, as discussed above. Additionally, the carrier 76 could be moved in the x-direction in row R1 to any of the columns C1 through C5. Similarly, any of the carriers 76 illustrated in FIG. 10 can be moved to any one of the units 24 in columns C1-C5 a rows R1-R5 by appropriately moving adjacent carriers 76 in either the x-direction or the y-direction.

With continued reference to FIG. 10, the controller 72 can also be used to inventory and track the product stored by the carriers 76. Therefore, a product can be loaded onto a carrier 76 and the location (i.e., column and row) can be tracked. Thus, when the user desires to retrieve the product from the storage and retrieval system 20, the user requests the product using the controller 72 and the controller 72 will automatically control the storage and retrieval system 20 to move the appropriate carrier 76 with the desired product to the location desired by the user, which can includes any one of the units located at columns C1-C5 and rows R1-R6.

Various features and advantages of the invention are set forth in the following claims.

What is claimed is:

1. A storage and retrieval system comprising:
a carrier defining a support surface configured to support a product stored by the storage and retrieval system, the carrier including a guide member rotatable with respect to the support surface from a first position to a second position such that the carrier is movable in a first direction when the guide member is in the first position and the carrier is movable in a second direction when the guide member is in the second position; and
a track assembly including a track member coupled to the guide member, the track member selectively rotatable from a first orientation to a second orientation such that the carrier is movable in the first direction when the track member is in the first orientation and the carrier is movable in the second direction when the track member is in the second orientation.

2. The storage and retrieval system of claim 1, further comprising a drive member operable to rotate the track member from the first orientation to the second orientation, and wherein rotation of the track member from the first orientation to the second orientation causes a corresponding rotation of the guide member from the first position to the second position.

3. The storage and retrieval system of claim 1, wherein the track assembly further includes a second track member and a third track member, the second and third track members held in a generally fixed position, wherein the first track member is aligned with the second track member when the first track member is in the first orientation and the first track member is aligned with the third track member when the first track member is in the second orientation.

4. The storage and retrieval system of claim 1, wherein the storage and retrieval system includes a plurality of carriers and a plurality of track assemblies, the plurality of track assemblies arranged to define a matrix.

5. The storage and retrieval system of claim 1, wherein the track member includes a rail, and wherein the guide member includes a wheel that rolls along the rail.

6. The storage and retrieval system of claim 5, wherein the rail includes a portion having a generally V-shaped cross-section, and wherein the wheel defines a generally V-shaped recess that receives the portion of the rail.

7. The storage and retrieval system of claim 5, wherein the track member includes a flange portion located above the wheel to substantially prevent movement of the carrier in an upward direction.

8. The storage and retrieval system of claim 1, wherein the track member includes a pipe, and wherein the guide member includes a wheel that rolls along the pipe.

9. The storage and retrieval system of claim 1, further comprising a drive member operable to move the carrier in the first and second directions.

10. The storage and retrieval system of claim 9, wherein the drive member includes an induction motor having a stator, and wherein the carrier is movable with respect to the stator.

11. The storage and retrieval system of claim 9, wherein the drive member includes a linear synchronous motor.

12. The storage and retrieval system of claim 1, further comprising a controller operable to automatically move the carrier to a predetermined location.

13. A storage and retrieval system comprising:
a plurality of carriers arranged to define a matrix, the plurality of carriers configured to support a product stored by the storage and retrieval system, at least one of the plurality of carriers selectively movable in a first direction and a second direction; and
a drive member operable to move the at least one of the plurality carriers in the first direction and the second direction, the at least one of the plurality of carriers movable with respect to at least a portion of the drive member.

14. The storage and retrieval system of claim 13, wherein the drive member includes an induction motor having a reaction plate and a stator, wherein the plurality of carriers are configured to move with respect to a floor, wherein the reaction plate is interconnected with the at least one of the plurality of carriers, and wherein the stator is configured to be held generally fixed with respect to the floor such that the at least one of the plurality of carriers and the reaction plate are movable with respect to the stator.

15. The storage and retrieval system of claim 14, wherein the storage and retrieval system includes a plurality of the induction motors, wherein the storage and retrieval system defines a plurality of cells that include at least a portion of one of the plurality of induction motors generally fixed within one of the plurality of cells.

16. The storage and retrieval system of claim 15, wherein the plurality of cells are at least partially defined by a track assembly including a track member selectively rotatable from a first orientation to a second orientation such that the carrier is movable in the first direction when the track member is in the first orientation and the carrier is movable in the second direction when the carrier is in the second orientation.

17. The storage and retrieval system of claim 16, wherein the carrier includes a wheel, wherein the track member includes a rail portion coupled to the wheel, and wherein the wheel is rotatable from a first position to a second position in response to rotation of the track member from the first orientation to the second orientation.

18. The storage and retrieval system of claim 13, wherein the drive member includes a linear synchronous motor.

19. A method of operating a storage and retrieval system, the method comprising:
moving a carrier configured to support a product stored by the storage and retrieval system in a first direction;
guiding movement of the carrier in the first direction using a track member in a first orientation;
rotating the track member from the first orientation to a second orientation; and
after rotating the track member, moving the carrier in a second direction.

20. The method of operating the storage and retrieval system of claim 19, wherein moving the carrier includes activating an induction motor.

21. The method of operating the storage and retrieval system of claim 19, wherein moving the carrier includes rolling a wheel of the carrier along the track member.

22. The method of operating the storage and retrieval system of claim 21, wherein rotating the track member rotates the wheel.
